(19) United States
(12) Patent Application Publication
(10) Pub. No.: US 2008/0044043 A1
(43) Pub. Date: Feb. 21, 2008

(54) CONDENSER MICROPHONE

(75) Inventors: Kentaro YONEHARA, Shizuoka-shi (JP); Norihiro SAWAMOTO, Shizuoka-shi (JP); Motoaki ITO, Shizuoka-shi (JP); Yasunori TSUKUDA, Shizuoka-shi (JP)

Correspondence Address: SUGHRUE-265550, 2100 PENNSYLVANIA AVE. NW, WASHINGTON, DC, 20037-3213, US

(73) Assignee: STAR MICRONICS CO., LTD, Shizuoka-shi (JP)

(21) Appl. No.: 11/842,431

(22) Filed: Aug. 21, 2007

(30) Foreign Application Priority Data
Aug. 21, 2006 (JP) P2006-224205
Aug. 31, 2006 (JP) P2006-236914

(51) Int. Cl. H04R 25/00

(52) U.S. Cl. 381/174

(57) ABSTRACT

A condenser microphone includes: a base frame including a containing space; a pair of substrates laminated to the base frame to close both end openings of the containing space; a condenser portion that is contained inside of the containing space; conductive layers formed on bonding surfaces of the base frame and the substrates opposed to each other; and exposed surfaces where the surfaces of a base frame main body and a substrate main body are exposed, the exposed surfaces being formed on outer peripheries of the conductive layers, wherein: the conductive layers of the base frame and the substrate are electrically connected; the exposed surfaces of the base frame main body and the substrate main body are adhered by an adhering agent; and an electric connection between the conductive layers is maintained by utilizing an adhering force of the adhering agent.

### CROSS REFERENCE TO RELATED APPLICATION

This application claims priority from a Japanese Patent Application No. 2006-224205 filed on Aug. 21, 2006, and a Japanese Patent Application No. 2006-236914 filed on Aug. 31, 2006, the entire subject matter of which is incorporated herein by reference.

### TECHNICAL FIELD

The present invention relates to a condenser microphone used in an apparatus of a portable telephone, a video camera, a personal computer or the like.

### BACKGROUND

In a related art, a condenser microphone has a configuration as disclosed in, for example, JP-A-2003-78997. The condenser microphone having the related art configuration is configured by laminating a circuit substrate mounted with an electric component, aback substrate having aback electrode, a spacer, a vibrating film support frame expanded with a vibrating film at a lower surface thereof which are integrally adhered to be fixed by an adhering agent.

Further, in a related art, an electret condenser microphone is described in, for example, JP-A-2003-163997. As shown in FIG. 13, the condenser microphone includes a metal-made cylindrical case 101 having a sound hole 102, and inside of the cylindrical case 101 is contained with a vibrating film 105 expanded by a metal-made film ring 104. The film ring 104 is brought into contact with an end surface of the cylindrical case 101. A side opposed to the end surface of the cylindrical case 101 relative to the vibrating film 105 is provided with a back electrode 111 (back electrode portion), and a surface of the back electrode 111 on a side of the vibrating film 105 is formed with an electret dielectric film 106 (electret portion) for maintaining a dielectric polarization state in the vibrating film 105.

The vibrating film 105 and the electret dielectric film 106 on a surface of the back electrode 111 are positioned opposedly in a state of being spaced apart from each other by a constant interval by interposing a spacer ring 109 made of an insulating material therebetween. Further, a side opposed to the vibrating film 105 relative to the back electrode 111 is provided with a metal-made conductive ring 113 formed in a cylindrical shape. The conductive ring 113 is brought into contact with the back electrode 111 at an upper end portion thereof and is electrically conducted to the back electrode 111.

A back space 117 is formed at a center portion of the conductive ring 113. An insulating ring 115 formed in a cylindrical shape is provided between the conductive ring 113 and the cylindrical case 101 to maintain a state of insulating the conductive ring 113 from the cylindrical case 101. Further, an entire peripheral edge of an upper end portion of the insulating ring 115 is formed with a stepped portion 115a to which the back electrode 111 is fitted to be held thereby.

A side opposed to the back electrode 111 relative to the conductive ring 113 is provided with a circuit substrate 120 having an impedance converting element 130 as impedance converting means. The circuit substrate 120 is fitted to a position of closing an open end portion of the cylindrical case 101, and the open end edge of the cylindrical case 101 is narrowed to the substrate on an inner side to be fastened to be fixed thereby.

Further, simultaneously with fixing the circuit substrate 120 to the cylindrical case 101, a wiring pattern 121 at an inner surface of the circuit substrate 120 is conducted to the conductive ring 113, and a wiring pattern 122 of an outer surface of the circuit substrate 120 is conducted to a side surface of the cylindrical case 101. By the configuration, a conductive layer, not illustrated, formed at the vibrating film 105 is conducted to the wiring pattern 122 by way of the film ring 104, the cylindrical case 101 and is grounded. Further, the condenser microphone is provided with an advantage capable of achieving an electromagnetic shielding effect by including the grounded cylindrical case 101.

### SUMMARY

According to the condenser microphone of JP-A-2003-78997, it is unavoidable to expose an adhering agent for adhering the circuit substrate, the back substrate, the spacer, and the vibrating film support frame to an inner portion of the microphone. Therefore, there is much concern of filling a gas generated from the adhering agent to an inner portion of the microphone, for example, in a procedure of curing the adhering agent. Further, in such a case, there is a concern that the electret layer for charging electric charge is devoid of electric charge by the gas to bring about a change in a characteristic of the microphone of a reduction in sensitivity or the like.

Further, according to the condenser microphone of the related art, the electric component is mounted to be fixed on the circuit substrate by a solder. Therefore, a gas is generated from a flux of a solder portion of the electric component by heat in reflow soldering or the like and is filled to inside of the microphone. Further, there have a problem that the electret layer is devoid of electric charge by the gas, similar to the above-described.

Further, in recent years, it is requested to downsize a condenser microphone. According to the condenser microphone of the related art, it is necessary to provide the cylindrical case 101 in order to ground the conductive layer formed in the vibrating film 105. However, according to the configuration, the cylindrical case is needed. Therefore, a number of parts is increased, as a result, there poses a problem that not only fabrication cost is increased but also downsizing is difficult.

Aspects of the invention provide a condenser microphone capable of restraining a gas from being generated at an inner portion of the microphone, capable of restraining the gas from invading the inner portion of the microphone, and capable of preventing a concern of deteriorating a characteristic of a sensitivity characteristic or the like.

Further, aspects of the invention provide a condenser microphone reducing a number of parts and achieving small-sized formation, as a result, achieving an electromagnetic shielding effect easily while reducing fabrication cost and a method of fabricating a laminated structure of a condenser microphone.

According to a first aspect of the invention, there is provided a condenser microphone including: a base frame including a containing space; a pair of substrates laminated to the base frame to close both end openings of the containing space; a condenser portion that is contained inside of the containing space; conductive layers formed on bonding surfaces of the base frame and the substrates opposed to each other; and exposed surfaces where the surfaces of a base frame main body and a substrate main body are exposed, the exposed surfaces being formed on outer peripheries of the conductive layers, wherein: the conductive layers of the base frame and the substrate are electrically connected; the exposed surfaces of the base frame main body and the substrate main body are adhered by an adhering agent; and an electric connection between the conductive layers is maintained by utilizing an adhering force of the adhering agent.

Therefore, according to the first aspect of the invention, even when a gas in accordance with curing the adhering agent is generated from an adhering portion between the exposed surfaces of the base frame main body and the substrate main body, the gas is blocked between the conductive layers bonded to each other for being connected electrically to be restrained from invading inside of the containing portion of the base frame. Therefore, an electret layer can be prevented from being devoid of electric charge by the gas, a concern of bringing about a reduction in a sensitivity characteristic or the like can be prevented.

According to a second aspect of the invention, in the condenser microphone according to the first aspect, the base frame main body and the substrate main body are made of resin materials, and the adhering agent is made of the similar materials to the base frame main body and the substrate main body.

Therefore, the base frame main body and the substrate main body can solidly be adhered to be fixed.

According to a third aspect of the invention, in the condenser microphone according to the first aspect, the adhering agent is a cure shrinking adhering agent.

Therefore, by curing to shrink the curing shrinking adhering agent, strength of fixing the base frame main body and the substrate main body can be increased, an excellent conduction can be ensured by increasing a contact pressure between the conductive layers, further, invasion of the gas generated from the adhering agent can effectively be prevented between the conductive layers.

According to a fourth aspect of the invention, in the condenser microphone according to any one of the first aspect, an electric component mounted to at least one of the substrates by a fixing method of not using an adhering member.

Therefore, the gas can be restrained from being generated from a fixed portion of the electric component by heat in reflowing or the like and the electret layer can further effectively be prevented from being devoid of electric charge.

According to a fifth aspect of the invention, in the condenser microphone according to the fourth aspect, the fixing method is a laser welding method.

Therefore, the electric component can be fixed to a predetermined position relative to the substrate accurately and in a short period of time, and the gas can be restrained from being generated from a flux since it is not necessary to use a solder.

According to a sixth aspect of the invention, in the condenser microphone according to the fourth aspect, the fixing method includes: fixing the electric component by a solder; and removing a flux of the solder.

Therefore, even when the solder is used, the gas can be prevented from being generated from the flux.

According to a seventh aspect of the invention, in the condenser microphone according to the first aspect, the substrates includes a mounting substrate and a top substrate, a vibrating film is laminated onto the base frame fixed onto the mounting substrate via a conductive spacer, the top substrate is laminated on the vibrating film; an electrode plate is arranged oppositely to a vibrating film conductive layer formed at the vibrating film, the condenser portion includes the vibrating film and the electrode plate, the base frame includes a conductive path for electrically connecting the conductive spacer and a conductive pattern of the mounting substrate; and a top substrate conductive layer, which is provided at the top substrate, is electrically connected with the conductive spacer.

Therefore, the top substrate conductive layer provided at the top substrate and the conductive spacer are electrically connected. Therefore, it is not necessary to provide a separate conductive cylindrical case at an external portion of the base frame and electrically connect the top substrate conductive layer and the conductive pattern by way of the cylindrical case. Further, the top substrate includes the top substrate conductive layer, and therefore, an electromagnetic shielding effect can be achieved.

According to a eighth aspect of the invention, in the condenser microphone according to the seventh aspect, the vibrating film conductive layer is provided at a surface on a side of the conductive spacer, and the top substrate conductive layer and the conductive spacer are electrically connected by folding back the vibrating film toward a side opposed to the vibrating film conductive layer.

Therefore, the top substrate conductive layer provided at the top substrate and the conductive spacer can electrically be connected by a simple operation of folding back the vibrating film to the side opposed to the surface of the side of providing the vibrating film conductive layer. As a result, the condenser microphone can simply be integrated.

According to a ninth aspect of the invention, in the condenser microphone according to the seventh aspect, the top substrate conductive layer and the conductive spacer are electrically connected by contacting the conductive spacer with the top substrate conductive layer directly.

Therefore, by the simple connection of bringing the conductive spacer into direct contact with the top substrate conductive layer, other member for connection is not needed for electrically connecting the conductive spacer and the top substrate conductive layer and a simple configuration can be configured.

According to a tenth aspect of the invention, in the condenser microphone according to the ninth aspect, the top substrate conductive layer and the conductive spacer are electrically connected by contacting a peripheral edge of the conductive spacer with the top substrate conductive layer directly.

Therefore, by bringing the peripheral edge of the conductive spacer into direct contact with the top substrate conductive layer to be arranged thereby, the peripheral edge of the conductive spacer is interposed to be arranged between the top substrate and the base frame, and therefore, the peripheral edge is brought into a state of being interposed between the top substrate and the base frame, a sufficient contact pressure is achieved and the conductivity is not hampered.

According to a eleventh aspect of the invention, in the condenser microphone according to the ninth aspect, the top substrate conductive layer and the conductive spacer are electrically connected by contacting a contact portion, which is provided at the conductive spacer, with the top substrate conductive layer directly by penetrating the vibrating film.

Therefore, by bringing the contact portion of the conductive spacer into direct contact with the top substrate conductive layer by penetrating the vibrating film to be arranged thereby, other member for connection is not separately needed for electrically connecting the conductive spacer and the top substrate conductive layer and a simple configuration can be constructed.

According to a twelfth aspect of the invention, in the condenser microphone according to the ninth aspect, the top substrate conductive layer and the conductive spacer are electrically connected by a projected portion that is provided at the top substrate conductive layer, penetrates the vibrating film, and contacts with the conductive spacer directly.

Therefore, by bringing the projected portion provided at the top substrate conductive layer into direct contact with the conductive spacer by way of the vibrating film to be arranged thereby, a member for connection is not separately needed for electrically connecting the conductive spacer and the top substrate conductive layer and a simple configuration can be constructed.

According to a thirteenth aspect of the invention, in the condenser microphone according to the ninth aspect, the top substrate conductive layer and the conductive spacer are electrically connected by a conductive connecting member arranged in a through hole formed at the vibrating film.

Therefore, the conductive spacer and the top substrate conductive layer are electrically connected at inside of the base frame, and therefore, an electric connecting member for connecting the conductive spacer and the top substrate conductive layer is not needed at an external portion of the base frame, the condenser microphone can be downsized, further, an interval between the conductive spacer and the top substrate conductive layer is configured by a short distance of about a film thickness of the vibrating film, and therefore, the conductive connecting member can be made to be small and fabrication cost can be reduced.

As described above, according to the invention, invasion of the gas to inside of the microphone can effectively be prevented and a reduction in a characteristic of a reduction in a sensitivity of the condenser microphone or the like can be prevented beforehand and a high function can be achieved.

Further, according to the invention, when the top substrate conductive layer and the conductive pattern of the mounting substrate are electrically connected, it is not necessary to provide the separate conductive cylindrical case at the external portion of the base frame and electrically connecting the top substrate conductive layer and the conductive pattern by way of the cylindrical case, and the cylindrical case can be omitted. As a result, a number of parts is reduced, and therefore, there is achieved an effect of capable of reducing fabrication cost and capable of downsizing a condenser microphone by an amount of dispensing with the conductive cylindrical case. According to the invention, the top substrate includes the top substrate conductive layer, and therefore, an electromagnetic shielding effect can be achieved.

### BRIEF DESCRIPTION OF THE DRAWINGS

In the accompanying drawings:

FIG. 1 is a sectional view showing a condenser microphone according to an embodiment;

FIG. 2 is a disassembled perspective view of the condenser microphone of FIG. 1;

FIG. 3 is a partial sectional view enlarging to show a portion of FIG. 1;

FIG. 4 is a perspective view showing a condenser microphone according to a second embodiment;

FIG. 5 is a plane view showing a relationship between a back plate and a spacer;

FIG. 6 is a vertical sectional view showing a condenser microphone;

FIG. 7 is a disassembled perspective view showing a condenser microphone;

FIG. 8 is a disassembled perspective view showing a condenser microphone according to a third embodiment;

FIG. 9 is a schematic sectional view of an essential portion for showing an electric connection relationship of respective members of the same;

FIG. 10 is a view in correspondence with FIG. 9 of other embodiment;

FIG. 11 is a view in correspondence with FIG. 9 of other embodiment;

FIG. 12 is a view in correspondence with FIG. 9 of other embodiment; and

FIG. 13 is a sectional view of a condenser microphone of a related art.

### DETAILED DESCRIPTION

### First Embodiment

An embodiment of the invention will be explained in reference to the drawings as follows.

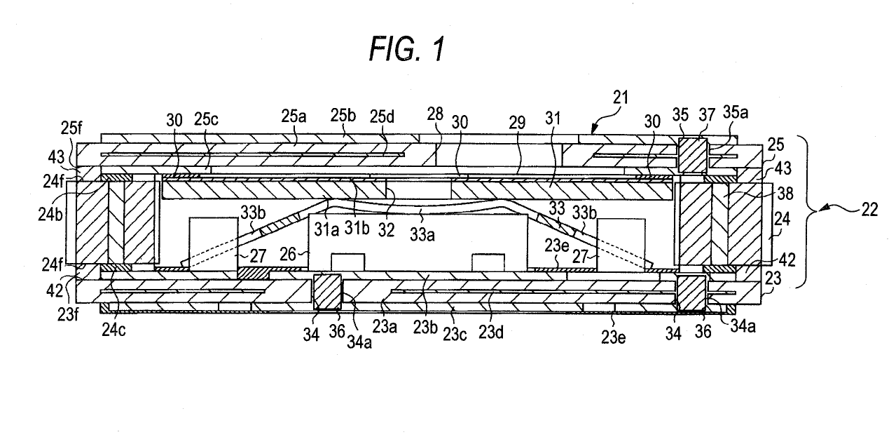

As shown by FIG. 1 through FIG. 3, according to a condenser microphone 21 of the embodiment, a casing 22 includes a circuit substrate 23 in a flat plate shape, a casing base frame 24 in a rectangular frame shape penetrated with a containing space, and a top substrate 25 in a flat plate shape. Further, the circuit substrate 23 and the top substrate 25 are laminated to the casing base frame 24 to close two upper and lower end openings of the containing space of the casing base frame 24, and adhered to be fixed by an adhering agent to configure the casing 22. Therefore, an upper surface of the circuit substrate 23, two upper and lower surfaces of the casing base frame 24, and a lower surface of the top substrate 25 configure bonding surfaces. Substrate main bodies 23a, 25a and a base frame main body 24a of the circuit substrate 23, the casing base frame 24 and the top substrate 25 are respectively configured by electric insulators of a synthetic resin of epoxy resin, liquid crystal polymer or the like, or a ceramic, according to the embodiment, these are configured by epoxy resin mixed with glass fiber.

Two upper and lower surfaces of the circuit substrate main body 23a of the circuit substrate 23 are printed with conductive layers 23b, 23c comprising copper or the like. Further, the substrate main body 23a configures a multilayer structure embedded with a conductive layer 23d comprising copper substantially at a center portion in a thickness direction, and by the configurations, promotion of a rigidity and a shielding property of the whole circuit substrate 23 is achieved. An insulating layer 23e is printed to surfaces of the two upper and lower surfaces of the substrate main body 23a which are not needed to be connected electrically.

Electric components 26, 27 of a field effect transistor, a capacitance and the like configuring an impedance converting circuit are mounted on the circuit substrate 23. The electric components 26, 27 are fixed to the circuit substrate 23 not by a method of using a solder or a conductive binder but by a laser welding method. Thereby, even when heat in a reflow soldering is applied, a gas is restrained from being generated from fixed portions of the electric components 26, 27. In the laser welding method, laser light is irradiated to boundaries between the electric components 26, 27 and the circuit substrate 23.

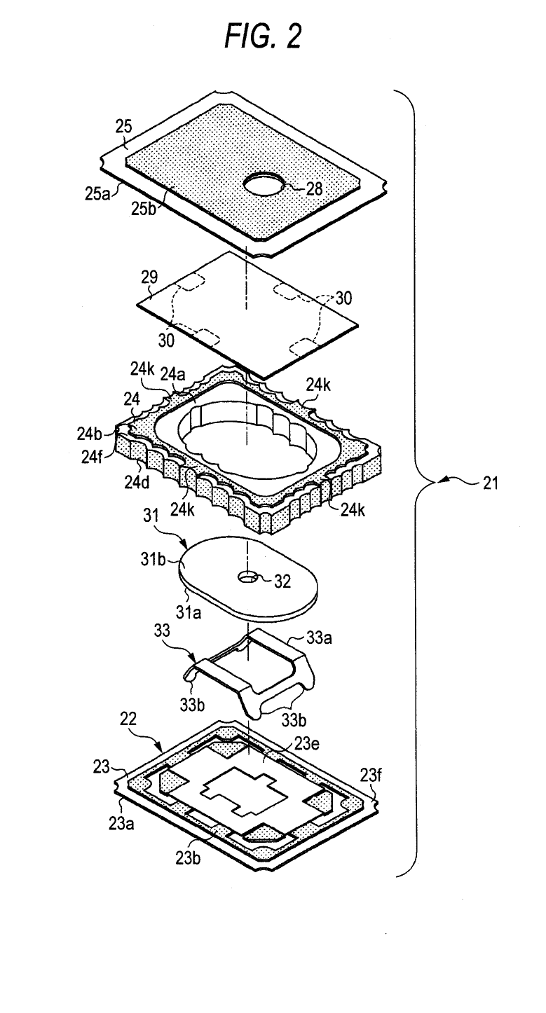

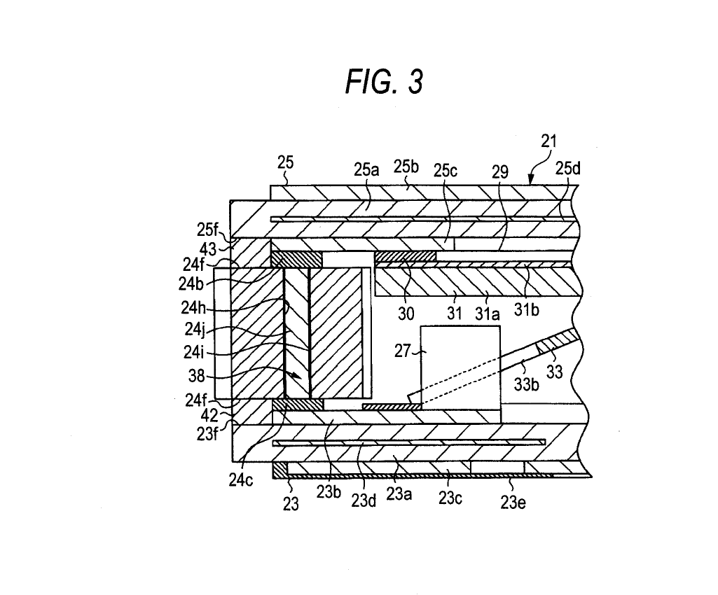

Conductive layers 24b, 24c, 24d comprising copper are printed to two upper and lower surfaces and an outer peripheral surface of the base frame main body 24a of the casing base frame 24. The electric components 26, 27 mounted onto the circuit substrate 23 are contained to be arranged at inside of the containing space of the casing base frame 24. As shown by FIG. 2, the upper and lower conductive layers 24b, 24c are connected to the conductive layer 24d at an outer periphery by way of bridging portions 24k at a plurality of portions. As shown by FIG. 3, the base frame main body 24a is formed with a plurality of through holes 24h, an inner peripheral surface of the through hole 24h is formed with a conductive layer 24i electrically connected to the conductive layers 24b, 24c at the two upper and lower surfaces, and inside of the through hole 24h is filled with a conductive member 24j to form a conductive portion.

Two upper and lower surfaces of the substrate main body 25a of the top substrate 25 are printed with conductive layers 25b, 25c comprising copper. The substrate main body 25a configures a multilayer structure embedded with a conductive layer 25d comprising copper substantially at a center portion in a thickness direction, thereby, promotion of a rigidity of the whole top substrate 25 and a shielding property is achieved. The top substrate 25 is formed with a sound hole 28 for taking sound from an external portion.

The circuit substrate 23 and the top substrate 25 are formed with pluralities of through holes 34, 35, inner peripheral surfaces of the through holes 34, 35 are formed with conductive layers 34a, 35a respectively electrically connected to the conductive layers 23b, 23c, 25b, 25c and insides of the through holes 34, 35 are filled with conductive members to form conductive portions 36, 37. Further, the conductive layer 23b on the upper surface side of the circuit substrate 23 and the conductive layer 24c on the lower surface side of the casing base frame 24, and the conductive layer 24b on the upper surface side of the casing base frame 24 and the conductive layer 25c on the lower surface side of the top substrate 25 are respectively brought into contact to be electrically conducted with each other. Further, a conductive path reaching a ground terminal, not illustrated, is formed from the conductive layers 25b, 25c and the conductive portion 37 including the through hole 35 of the top substrate 25 by way of the conductive layer 24b, the conductive layer 24i including the through hole 24h and the conductive layer 24c of the casing base frame 24, similarly, the conductive layer 24b of the casing base frame 24, the bridging portion 24k and the conductive layer 24c, the conductive layers 23b, 23c on the circuit substrate 23 and the conductive portion 36 including the through hole 34.

As shown by FIG. 1 through FIG. 3, at inside of the casing base frame 24, a lower surface of the lower side conductive layer 25c of the top substrate 25 is adhered to be expanded with a vibrating film 29 comprising a synthetic resin thin film sheet member of PPS (polyphenylene sulfide) or the like, and a lower surface of the vibrating film 29 is formed with a conductive layer configured by vapor-depositing gold, not illustrated. Further, although not illustrated, the conductive layer configured by vapor-depositing gold is electrically conducted to the conductive layer 25c of the top substrate 25. Four portions on a periphery side of a lower surface of the vibrating film 29 are adhered to be fixed with spacers 30 in a shape of a small piece comprising a synthetic resin of PPS or the like of a species the same as that of the material of the vibrating film 29. At inside of the casing base frame 24, a lower surface of the spacer 30 is opposedly arranged with a back plate 31 as an electrode plate to be able to move in an up and down direction. The back plate 31 is configured by a structure of providing an electret layer 31b as a back electrode comprising a synthetic resin film of PTFE (polytetrafluoroethylene) or the like at an upper surface of a plate main body 31a comprising a stainless steel plate. The electret layer 31b is configured by subjecting the PTFE to a polarizing treatment by corona discharge or the like.

Further, the back plate 31 is formed to substantially configure an oval shape in a shape of a plane smaller than an inner diameter of the casing base frame 24, and formed with a through hole 32 at a center thereof. A condenser portion is configured by the back plate 31, the vibrating plate 29 and the like.

As shown by FIG. 1 through FIG. 3, at inside of the casing base frame 24, a holding member 33 comprising a leaf spring is interposed between the back plate 31 and the circuit substrate 23 in a compressed state, and the back plate 31 is pressed from a side opposed to the vibrating film 29 in a direction of being brought into contact with a lower surface of the spacer 30 by the holding member 33. Thereby, a predetermined interval is maintained between the vibrating film 29 and the back plate 31 and the condenser portion is configured by the vibrating film 29 and the back plate 31. The holding member 33 is integrally formed by punching a plate member configured by subjecting two head and tail surfaces of a stainless steel plate to gold plating, and includes a support frame portion 33a substantially in a shape of a rectangular frame, and four leg portions 33b sideling projected from four corners of the support frame portion 33a in two lower side directions. The back plate 31 is electrically connected to the circuit substrate 23 by way of the holding member 33.

Next, a detailed explanation will be given of a structure of laminating to fix the circuit substrate 23, the casing base frame 24 and the top substrate 25.

As shown by FIG. 1 and FIG. 2, exposed surfaces 23f, 25f, 24f respectively exposing surfaces thereof of epoxy resin are formed at an outer periphery of an upper surface of the substrate main body 23a of the circuit substrate 23, an outer periphery of a lower surface of the substrate main body 25a of the top substrate 25 and outer peripheries of two upper and lower surfaces of the base frame main body 24a of the casing base frame 24. Adhering agents 42, 43 are interposed among the exposed surfaces 23f, 25f, 24f for adhering. By adhering forces of the adhering agents 42, 43, the conductive layer 23b of the upper surface of the circuit substrate 23 and the conductive layer 25c of the lower surface of the casing base frame 24 as well as the conductive layer 24c of the lower surface of the top substrate 25 and the conductive layer 24b of the upper surface of the casing base frame 24 are respectively bonded directly to be maintained in an electrically connected state.

As the adhering agents 42, 43, there are used adhering agents of epoxy resin of a species the same as that of materials of the circuit substrate main body 23a, the top substrate main body 25a and the casing base frame main body 24a without using a conductive binder. The epoxy resin adhering agent is provided with a curing shrinkage property and a shrinkage rate thereof is comparatively large.

In the condenser microphone 21 of the embodiment configured as described above, when a sound wave from a sound source reaches the vibrating frame 29 by way of the sound hole 28 of the top substrate 25, the vibrating film 29 is vibrated in accordance with a frequency, an amplitude and a waveform of sound. Further, in accordance with vibration of the vibrating film 29, an interval between the vibrating plate 29 and the back plate 31 is changed from a set value to change an impedance of the condenser. A change in the impedance is converted into a voltage signal by an impedance converting circuit to be outputted.

The condenser microphone 21 of the embodiment configured as described above achieve the following effects.

(1) In the condenser microphone 21 of the embodiment, even when a gas in accordance with curing or heating the adhering agents 43, 42 is generated from the adhering agents 43, 42 of adhering portions among the exposed surfaces 24f, 23f, 25f of the base frame main body 24a of the casing base frame 24 and the substrate main bodies 23a, 25a of the circuit substrate 23, the top substrate 25, the gas is blocked at the conductive layers 25c, 24b and 24c, 23b bonded to each other for electric connection. Therefore, the gas is prevented from invading inside of the containing space of the casing base frame 24. Therefore, the electret layer 31b can be prevented from being devoid of electric charge by the gas and a concern of bringing about a reduction in a sensitivity characteristic or the like can be prevented.

Further, although in the above-described, invasion of the gas to inner portions of the casing base frame 24 is restrained by the conductive layers 25c, 24b and 24c, 23b, in place of the conductive layers 25c, 24b and 24c, 23b, portions of preventing the adhering agents from flowing in may be formed by a resin material similar to that of the casing base frame 24 and conductive layers may be formed at portions thereof. In this way, the adhering agents of the bonding portions may be blocked so as not to reach inner portions of the casing base frame 24.

(2) Curing shrinkage adhering agents are used as the adhering agents 42, 43. Therefore, by curing to shrink the adhering agents 42, 43, attracting forces are operated among the circuit substrate 23, the casing base frame 24 and the top substrate 25. Therefore, these can be fixed to each other solidly, contact pressures among the conductive layers 23b, 24c, 24b, 25c of the substrates 23, 25 and the base frame 24 can be increased, and excellent conduction can be achieved.

(3) As described above, the contact pressures among the conductive layers 23b, 24c, 24b, 25c can be increased by operating attracting forces among the circuit substrate 23, the casing base frame 24 and the top substrate 25, and therefore, invasion of the gas to inside of the containing space of the casing base frame 24 can further effectively be prevented.

(4) As the adhering agents 42, 43, the adhering agents of the epoxy resin species the same as the species of the circuit substrate 23, the casing base frame 24 and the top substrate 25 are used, and therefore, compatibilities of the adhering agents 42, 43 with the two substrates 23, 25 and the base frame 24 are excellent and the circuit substrate 23, the casing base frame 24 and the top substrate 25 can solidly be adhered to be fixed.

(5) The electric components 26, 27 are fixed onto the circuit substrate 23 not by a soldering method using a solder and a flux but by a laser welding fixing method. Therefore, a gas is not generated from portions of fixing the electric components 26, 27 to the circuit substrate 23 by heat in reflow soldering of the condenser microphone 21. Therefore, the electret layer 31b can be prevented from being devoid of electric charge and a concern of bringing about a reduction in a characteristic, that is, a reduction in a sensitivity or the like can be prevented.

(6) As described above, by fixing the electric components 26, 27 to the circuit substrate 23 by laser welding, the electric components 26, 27 can be fixed to predetermined positions relative to the circuit substrate 23 accurately and in a short period of time.

Further, the embodiment can also be realized by being changed as follows.

Although according to the above-described embodiment, the electric components 26, 27 are fixed by the laser welding fixing method, the electric components 26, 27 are fixed to the circuit substrate 23 by a soldering method of using a solder and a flux. However, in this case, a treatment of removing the flux by cleaning or the like is carried out after soldering. Thereby, the problem of generating the gas from the flux is not posed.

In the consider microphone 21 of the embodiment, the electric components 26, 27 are fixed to the circuit substrate 23 by other fixing method of not using an adhering member of ultrasonic welding, spot welding, ionizing welding different from laser welding.

The invention is realized by an electret type condenser microphone of a foil electret type providing a function of an electret to the vibrating film 29 in place of the back plate 31.

The invention is realized by a condenser microphone of a charge pump type which is not provided with a function of an electret both in the back plate 31 and the vibrating film 29 and in which a voltage is applied to the back plate 31 and the vibrating film 29 by a charge pump circuit.

The invention is realized by a casing of a condenser microphone of MEMS (Micro Electro Mechanical System) type formed with a condenser portion including a vibrating electrode plate and a fixed electrode plate arranged opposedly to the vibrating electrode plate on a silicon substrate by a semiconductor process technology.

### Second Embodiment

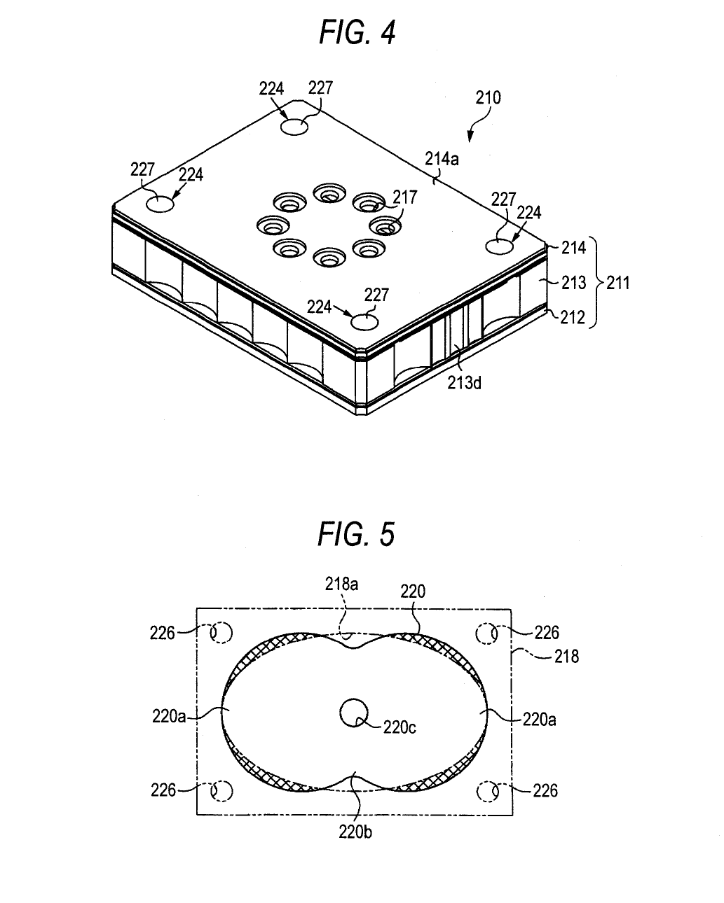

Next, an explanation will be given of a second embodiment of realizing the invention by a condenser microphone of an electret type in reference to FIG. 4 through FIG. 7.

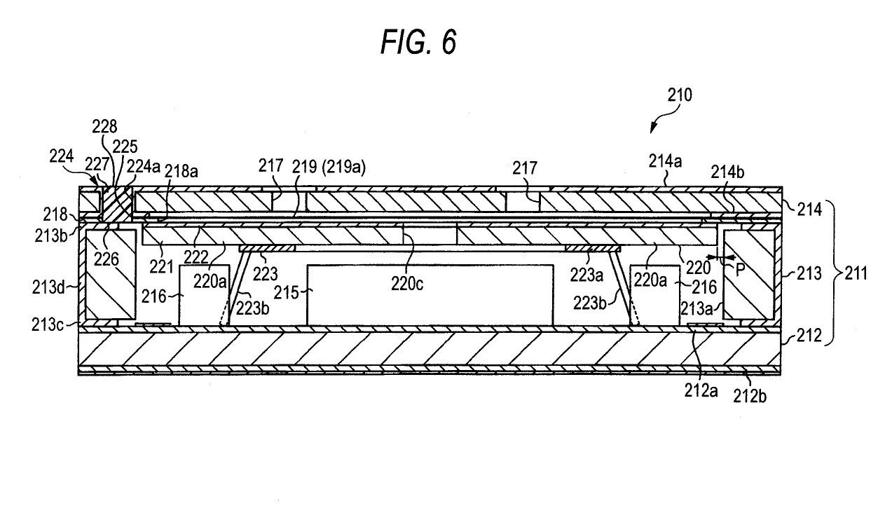

As shown by FIG. 4 and FIG. 6, a casing 211 of a condenser microphone 210 is configured by a structure of laminating a circuit substrate 212 in a flat plate shape as a mounting substrate, a casing base frame 213 in a rectangular frame shape, and a top substrate 214 in a flat plate shape to be fixed integrally by an adhering agent. The circuit substrate 212, the casing base frame 213 and the top substrate 214 are configured by electric insulators of epoxy resin, liquid crystal polymer, ceramic or the like.

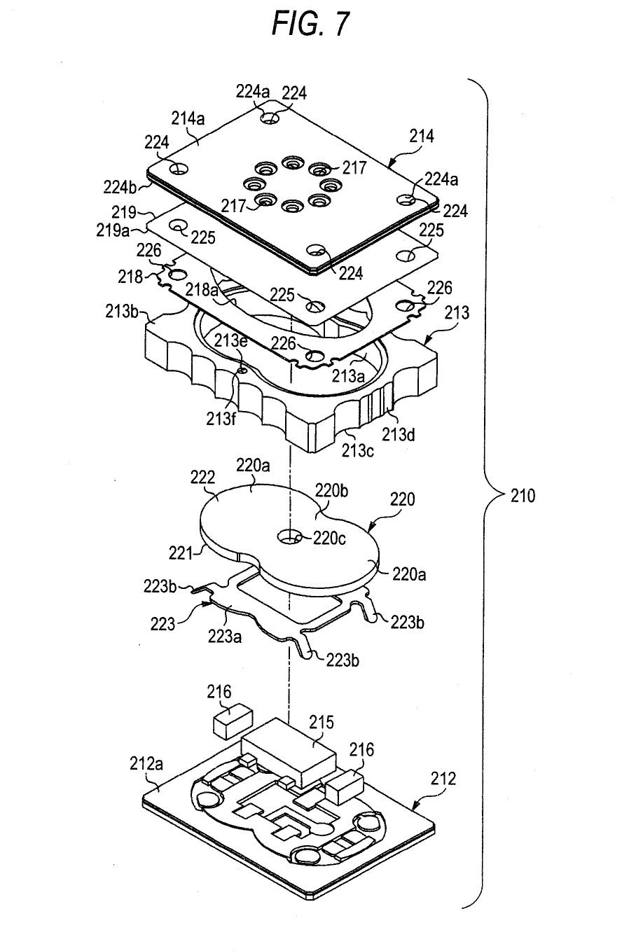

As shown by FIG. 6 and FIG. 7, conductive patterns 212a, 212b comprising copper are formed at two upper and lower surfaces of the circuit substrate 212. The two conductive patterns 212a, 212b are electrically connected to each other, and a ground terminal, not illustrated, is provided to the conductive pattern 212b on the lower surface side. Further, electric components of a field effect transistor 215, a capacitor 216 and the like provided at inside of the casing 211 and configuring an impedance converting circuit are mounted on the circuit substrate 212. The casing base frame 213 is formed with a containing hole 213a substantially in a gourd shape connected with a pair of circuit portions by way of a neck portion. Further, the electric components of the field effect transistor 215, the capacitor 216 and the like are contained to be arranged at inside of the containing hole 213a of the casing base frame 213. Two upper and lower surfaces and outer side surfaces of the casing base frame 213 are formed with conductive patterns 213b, 213c, 213d comprising copper and electrically connected to each other, and the conductive pattern 213c on the lower surface side is brought into contact with the conductive pattern 212a to be electrically connected thereto. As shown by FIG. 7, in the casing base frame 213, a through hole 213f is formed at a position in correspondence with the neck portion of the containing hole 213a, and the conductive patterns 213b, 213c are electrically connected to each other by way of a conductive layer 213e formed on an inner peripheral surface thereof. Further, also the conductive pattern 213d formed at the side surface is electrically connected to the conductive patterns 213b, 213c.

The conductive patterns 213b, 213c, 213d and the conductive layer 213e correspond to a conductive path for electrically connecting a spacer 218 and the conductive pattern 212a of the circuit substrate 212.

Conductive patterns 214a, 214b comprising copper are formed on two upper and lower surfaces of the top substrate 214. The conductive patterns 214a, 214b correspond to top substrate conductive layers. A center portion of the top substrate 214 is formed with a plurality of sound holes 217 to configure a ring-like shape as a whole.

The spacer 218 comprising a metal plate is interposed between the casing base frame 213 and the top substrate 214 to be fixed thereby, and the spacer 218 is penetrated with a hole 218a in an elliptical shape. The spacer 218 is formed by, for example, a stainless steel plate, titanium or the like. The spacer 218 corresponds to a conductive spacer. An upper surface of the spacer 218 is expanded with a vibrating film 219 comprising a polymer film by adhering, and a lower surface of the vibrating film 219 is formed with a conductive layer 219a. The polymer film comprises, for example, PPS (polyphenylene sulfide) and the conductive layer 219a is formed by, for example, vapor-depositing gold. The conductive layer 219a corresponds to a vibrating film conductive layer.

At inside of the casing base frame 213, a back plate 220 as an electrode plate is opposedly arranged at a lower surface of the vibrating film 219 by way of the spacer 218. The back plate 220 is formed substantially by a gourd shape in correspondence with the containing hole 213a, and is configured by pasting an electret film 222 comprising a polymer film of, for example, PTFE (polytetrafluoroethylene) or the like to an upper surface of the back electrode 221 comprising a conductive metal plate. The back electrode 221 comprises, for example, a stainless steel plate, and the electret film 222 comprises PTFE subjected to a polarizing treatment by corona discharge or the like. That is, the condenser microphone 210 of the embodiment is of a back electret type providing the electret film 222 at the back electrode 221 as the fixed electrode.

As shown by FIG. 7, the back plate 220 is formed by a shape of connecting a pair of circular portions 220a by way of a connecting portion 220b in a necked shape, and contained at inside of the containing hole 213a of the casing base frame 213 in a state of providing a clearance P (illustrated in FIG. 6) between an outer peripheral surface thereof and an inner peripheral surface of the containing hole 213a. Further, as shown by FIG. 5, the back plate 220 is brought into contact with the spacer 218 at portions of peripheral edges of the respective circular portions 220a and a peripheral edge of the connecting portion 220b is arranged in correspondence with the hole 218a of the spacer 218. Further in details, the back plate 220 is brought into contact with the spacer 218 at respective two portions (netted portion) of the respective circular portions 220a. Further, a center portion of the back plate 220 is formed with a hole 220c for permitting air to move by a vibration of the vibrating film 219.

As shown by FIG. 6, at inside of the casing base frame 213, a holding member 223 comprising a spring member is interposed between the back plate 220 and the circuit substrate 212 in a compressed state and the back plate 220 is pressed in a direction of being brought into contact with a lower surface of the spacer 218 on a side opposed to the vibrating film 219. Thereby, a predetermined interval is maintained between the vibrating film 219 and the back plate 220 and a condenser portion ensuring a predetermined capacitance is formed therebetween. The holding portion 223 is formed by punching a plate member configured by subjecting two head and tail surfaces of a stainless steel plate to gold plating and includes a frame portion 223a substantially in a shape of a rectangular ring, and four leg portions 223b skewedly projected from four corners of the frame portion 223a in two lower side directions. Further, the holding member 223 brings an upper surface of the frame portion 223a into contact with a lower surface of the back plate 220 and brings lower ends of the respective leg portions 223b into contact with the conductive pattern 212a on the circuit substrate 212. Therefore, the back electrode 221 of the back plate 220 is electrically connected to an impedance converting circuit on the circuit substrate 212 by way of the holding member 223.

As shown by FIG. 6, FIG. 7, the top substrate 214 is formed with a plurality of through holes 224, and the two conductive patterns 214a, 214b are electrically connected by way of conductive layers 224a formed on inner peripheral surfaces thereof.

Further, the vibrating film 219 is formed with a hole 225 as a through hole in correspondence with the through hole 224, and the spacer 218 is formed with a hole 226 in correspondence with the hole 225. As shown by FIG. 6, a conductive resin 227 is filled at insides of the through hole 224 and the two holes 225, 226, and a conductive portion 228 is formed by the conductive resin 227. Further, the two conductive patterns 214a, 214b of the top substrate 214 are electrically connected to the conductive patterns 213b through 213d of the casing base frame 213 by way of the conductive layer 224a of the through hole 224 and the conductive portion 228, and the conductive layer 219a of the vibrating film 219 and the spacer 218 are electrically connected to the conductive patterns 213b through 213d by way of the conductive portion 228.

The conductive resin 227 corresponds to a conductive connecting member and is connected to the conductive patterns 214a, 214b (top substrate conductive layers) and the spacer 218 by being arranged, that is, filled in the hole 225. Further, electric connecting means for electrically connecting the conductive patterns 214a, 214b provided at the top substrate 214 and the spacer 218 is configured by the conductive resin 227 in this way. Further, a laminated structure is formed by laminating the casing base frame 213, the spacer 218, the vibrating film 219 and the top substrate 214.

According to the embodiment, when the laminated structure is formed, there is included a step of connecting the spacer 218 to the conductive pattern 213b (conductive path) and the conductive layer 213e (conductive path) of the casing base frame 213 connected to the conductive pattern 212a of the circuit substrate 212 by a conductive adhering agent. Further, according to the embodiment, there is included a step of electrically connecting the spacer 218 to the conductive patterns 214a, 214b of the top substrate 214 indirectly by way of the conductive resin 227.

In this way, an electromagnetic shield covering the condenser portion and the impedance converting circuit is configured by the two conductive patterns 214a, 214b of the top substrate 214, the conductive patterns 213b through 213d of the casing base frame 213, and the two conductive patterns 212a, 212b of the circuit substrate 212. Further, also the through hole 213f achieves an electromagnetic shielding function.

Now, when a sound wave from a sound source reaches the vibrating film 219 by way of the respective sound holes 217 of the top substrate 214, the vibrating film 219 is vibrated in accordance with a frequency, an amplitude and a waveform of the sound wave. Further, an interval between the vibrating film 219 and the back plate 220 is changed relative to a set value in accordance with vibration of the vibrating film 219 and a capacitance of the condenser is changed. A change in the capacitance is outputted by being converted into a voltage signal by the impedance converting circuit.

The condenser microphone 210 of the embodiment operated as described above achieves the following effects.

(1) According to the condenser microphone 210 of the embodiment, the casing base frame 213 is provided with the conductive patterns 213b, 213c, 213d (conductive path), and the conductive layer 213e (conductive path) for electrically connecting the spacer 218 and the conductive pattern 212a of the circuit substrate 212. Further, the conductive patterns 214a, 214b (top substrate conductive layers) provided at the top substrate 214 and the spacer 218 are electrically connected by the conductive resin 227 (electric connecting means).

As a result, according to the embodiment, when the conductive patterns 214a, 214b and the conductive pattern 212a of the circuit substrate 212 are electrically connected, it is not necessary to provide a separate conductive cylindrical case at an external portion of the casing base frame 213 to electrically connect the top substrate conductive layer and the conductive pattern by way of the cylindrical case, and the cylindrical case can be omitted. As a result, a number of parts is reduced, and therefore, fabrication cost can be reduced. Further, an effect of capable of being downsized is achieved by an amount of dispensing with the conductive cylindrical case. Further, according to the embodiment, the top substrate 214 includes the conductive patterns 214a, 214b, and therefore, an electromagnetic shielding effect can be achieved.

(2) Further, according to the embodiment, when a laminated structure laminated with the casing base frame 213, the spacer 218, the vibrating film 219 and the top substrate 214 is formed, there is included a step of connecting the spacer 218 to the conductive pattern 213b and the conductive layer 213e of the casing base frame 213 connected to the conductive pattern 212a of the circuit substrate 212 by the conductive adhering agent. Further, according to the embodiment, there is included a step of electrically connecting the spacer 218 to the conducive patterns 214a, 214b of the top substrate 214 indirectly by way of the conductive resin 227. As a result, the laminated structure of the condenser microphone capable of realizing operation and effect of the above-described (1) can easily be provided.

### Third Embodiment

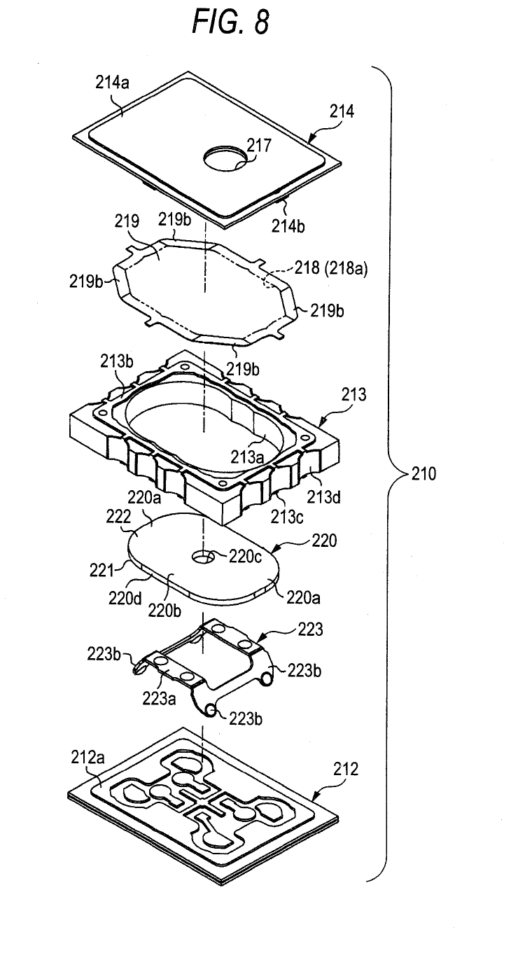

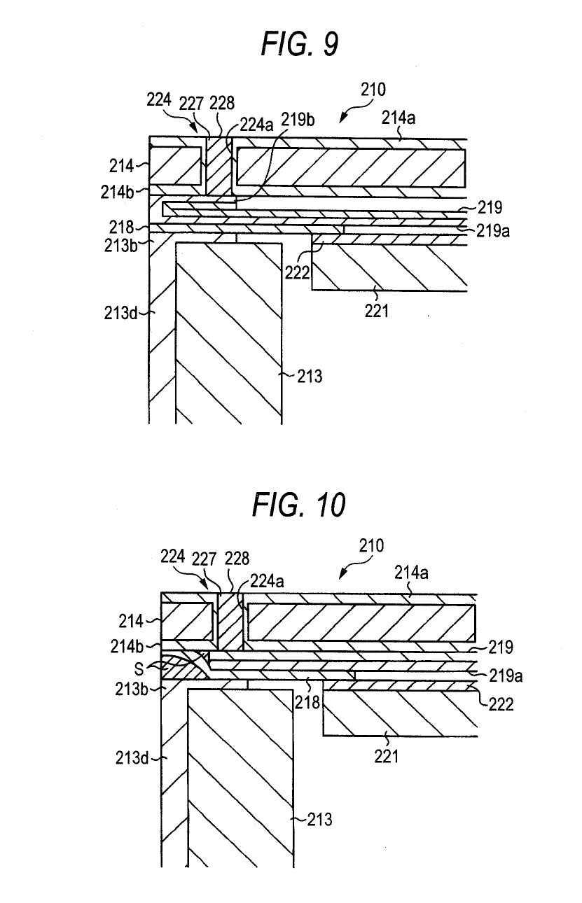

Next, a third embodiment of realizing the invention will be explained in reference to FIG. 8 and FIG. 9. Although a configuration of the third embodiment is basically the same as the configuration of the second embodiment, configurations of respective constituent members slightly differ from configurations of corresponding constituent members in the second embodiment. Further, in the following embodiment, configurations the same as or corresponding to those of the second embodiment are attached with notations the same as those of the second embodiment, a detailed explanation thereof will be omitted, and an explanation will be given of different points of the respective constituent members.

As shown by FIG. 8, the top substrate 214 is formed with a single sound hole 217 at a position deviated from a center portion. The spacer 218 is formed by a shape of an octagonal frame and includes the hole 218a in an octagonal shape. The lower surface of the vibrating frame 219 expanded to the upper surface of the spacer 218 is formed with a conductive layer 219a and end edges of four corners of the vibrating film 219 are provided with a fold back portion 219b folded back to an upper side by 180 degrees. As shown by FIG. 9, the fold back portion 219b is brought into contact with the conductive pattern 214b of the top substrate 214. It is preferable that a front end of the fold back portion 219b does not come to an inner side of an inner peripheral edge of the spacer 218 since vibration of the vibrating film 219 is not hampered thereby. Further, FIG. 9 is a schematic view of an essential portion for showing an electric connection relationship of respective members and thicknesses of respective members are illustrated exaggeratingly enlarged for convenience of explanation.

Therefore, the conductive layer 219a on the vibrating film 219 is connected to the conductive pattern 214b of the top substrate 214 at the end edges of the four corners of the vibrating film 219. Therefore, the conductive patterns 214a, 214b of the top substrate 214 are electrically connected to the conductive patterns 213b through 213d of the casing base frame 213 by way of the conductive layer 219a of the fold back portion 219b. The back plate 220 configures substantially an oval shape as a whole and is formed by a shape of connecting a pair of substantially circular portions 220a and providing parallel sides 220d between the circular portions 220a. Further, the fold back portion 219b and the conductive pattern 214b as well as the conductive layer 219a and the conductive pattern 213b are brought into press contact with each other to be conducted to each other by bringing the top substrate 214 and the casing base frame 213 into press contact with each other to be bonded to each other, and conductive bonding by a conductive adhering agent or the like is not needed.

The third embodiment is provided with the following characteristics other than operation and effect of (1) of second embodiment.

(1) According to the third embodiment, the conductive layer 219a configuring a vibrating film conductive layer is provided to a surface on a side of the spacer 218, and the vibrating film 219 is folded back to a side opposed to a surface on a side of providing the conductive layer 219a as electric connecting means. As a result, according to the third embodiment, the conductive pattern 214b provided at the top substrate 214 and the spacer 218 can electrically be connected by a simple operation of folding back the vibrating film 219 to a side opposed to a surface of a side of providing the conductive layer 219a. As a result, the condenser microphone 210 can simply be integrated.

(2) According to the third embodiment, when the laminated structure laminated with the casing base frame 213, the spacer 218, the vibrating film 219 and the top substrate 214 is formed, the laminated structure can be formed by a step of connecting the spacer 218 to the conductive pattern 213b and the conductive layer 213e of the casing base frame 213 connected to the conductive pattern 212a of the circuit substrate 212 by a conductive adhering agent similar to the second embodiment. Further, according to the third embodiment, by forming the fold back portions 219b at the four corners of the vibrating film 219, the spacer 218 can electrically be connected to the conductive patterns 214a, 214b of the top substrate 214 indirectly by way of the conductive layers 219a of the fold back portions 219b at the four corners of the vibrating film 219.

Further, the embodiment can be realized by being changed as follows.

As a modified example of the third embodiment, as shown by FIG. 10, a portion or the whole peripheral edge of the vibrating film 219 is made to be shorter than the spacer 218 and an outer peripheral portion of the spacer 218 is adhered to the conductive pattern 214b of the top substrate 214 directly by way of a conductive adhering agent S. According to the embodiment, electric connecting means is configured by bringing the peripheral edge of the spacer 218 into direct contact with the conductive pattern 214b to be arranged thereby. Thereby, by bringing the peripheral edge of the spacer 218 into direct contact with the conductive pattern 214b of the top substrate 214 (top substrate conductive layer) to be arranged thereby, the peripheral edge of the spacer 218 is arranged to be interposed between the top substrate 214 and the casing base frame 213. Therefore, the peripheral edge is brought into a state of being interposed between the top substrate and the casing base frame, a sufficient contact pressure is achieved and the conductivity is not hampered.

Further, according to the embodiment, when the laminated structure laminated with the casing base frame 213, the spacer 218, the vibrating film 219 and the top substrate 214 is formed, similar to the second embodiment, the laminated structure can be formed by a step of connecting the spacer 218 to the conductive pattern 213b and the conductive layer 213e of the casing base frame 213 connected to the conductive pattern 212a of the circuit substrate 212 by the conductive adhering agent. Further, according to the embodiment, by shortening to form a portion or all of the peripheral edge of the vibrating film 219, the spacer 218 can directly be connected electrically to the conductive pattern 214b of the top substrate 214.

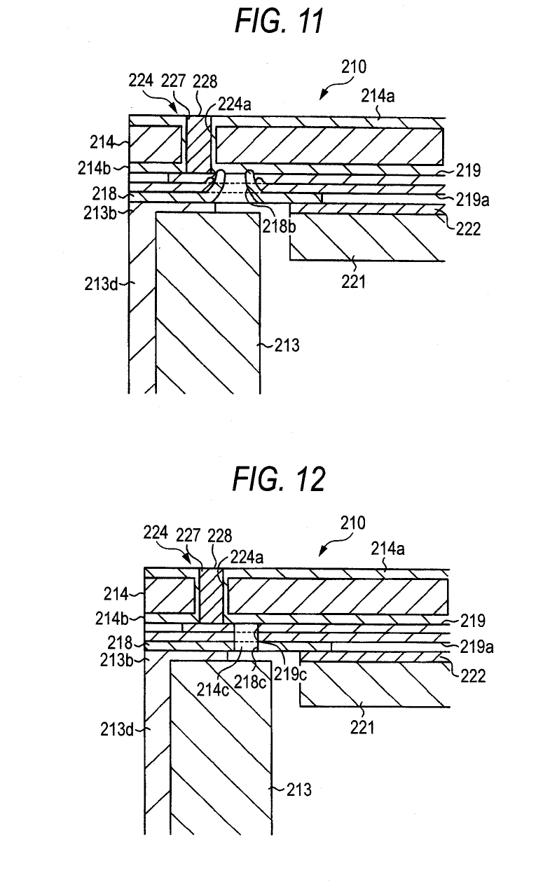

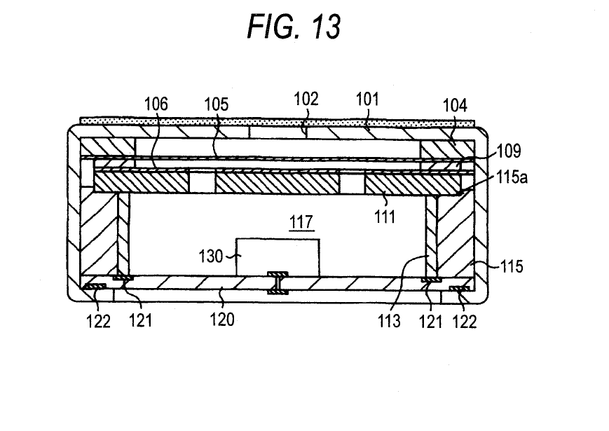

Further, as a modified example of the third embodiment, as shown by FIG. 11, a penetrated hole is formed at the spacer 218 from below by a jig or the like, and a burr 218b as a contact portion produced at this occasion is brought into contact with the conductive pattern 214b of the top substrate 214. According to the embodiment, the electric connecting means is configured by penetrating the burr 218b provided at the spacer 218 through the vibrating film 219 to be brought into direct contact with the conductive pattern 214b to be arranged thereby. Thereby, the burr 218b of the spacer 218 is directly brought into contact with the conductive pattern 214b of the top substrate 214 (top substrate conductive layer) to be arranged thereby. According to the embodiment, by bringing the burr 218b of the spacer 218 into direct contact with the conductive pattern 214b by penetrating the vibrating film 219 to be arranged thereby, other member for connection is not separately needed for electrically connecting the spacer 218 and the conductive pattern 214b and a simple configuration can be constructed.

Further, according to the embodiment, when the laminated structure laminated with the casing base frame 213, the spacer 218, the vibrating film 219 and the top substrate 214 is formed, the laminated structure can be formed by a step of connecting the spacer 218 to the conductive pattern 213b and the conductive layer 213e of the casing base frame 213 connected to the conductive pattern 212a of the circuit substrate 212 by a conductive adhering agent similar to the second embodiment. Further, according to the embodiment, the spacer 218 can electrically be connected directly to the conductive pattern 214b of the top substrate 214 by penetrating the burr 218b as the contact portion through the vibrating film 219 to the spacer 218.

As a modified example of the third embodiment, as shown by FIG. 12, fitting holes 218c, 219c are formed respectively to the spacer 218 and the vibrating film 219, the conductive pattern 214b is integrally formed with a projected portion 214c and the projected portion 214c is fitted to the fitting holes 218c, 219c. According to the embodiment, the electric connecting means is configured by bringing the projected portion 214c provided at the conductive pattern 214b into direct contact with the spacer 218 by penetrating the vibrating film 219 to be arranged thereby. Further, the projected portion 214c is formed by a bump or the like. The conductive pattern 214b and the spacer 218 are conducted by the projected portion 214c. By configuring in this way, the projected portion 214c provided at the conductive pattern 214b is brought into direct contact with the spacer 218 by way of the vibrating film 219 to be arranged thereby, and therefore, a member for connection for electrically connecting the spacer 218 and the conductive pattern 214b is not separately needed and a simple configuration can be constructed.

According to the embodiments of FIGS. 10 through 12, the conductive layer 219a of the vibrating film 219 may be provided at an upper surface thereof.

The invention is realized by a condenser microphone of a foil electret type configuring an electret film by the vibrating film 219 instead of providing the electret film 222 at the back plate 220.

The invention is realized by a condenser microphone of a charge pump type for applying a voltage between the back plate 220 and the vibrating film 219 by a charge pump circuit at an external portion without providing the electret film 222.

What is claimed is:

1. A condenser microphone comprising:
a base frame including a containing space;
a pair of substrates laminated to the base frame to close both end openings of the containing space;
a condenser portion that is contained inside of the containing space;
conductive layers formed on bonding surfaces of the base frame and the substrates opposed to each other; and
exposed surfaces where the surfaces of a base frame main body and a substrate main body are exposed, the exposed surfaces being formed on outer peripheries of the conductive layers, wherein:
the conductive layers of the base frame and the substrate are electrically connected;
the exposed surfaces of the base frame main body and the substrate main body are adhered by an adhering agent; and
an electric connection between the conductive layers is maintained by utilizing an adhering force of the adhering agent.

2. The condenser microphone according to claim 1, wherein
the base frame main body and the substrate main body are made of resin materials; and
the adhering agent is made of the similar materials to the base frame main body and the substrate main body.

3. The condenser microphone according to claim 2, wherein
the adhering agent is a cure shrinking adhering agent.

4. The condenser microphone according to claim 1, further comprising
an electric component mounted to at least one of the substrates by a fixing method of not using an adhering member.

5. The condenser microphone according to claim 4, wherein
the fixing method is a laser welding method.

6. The condenser microphone according to claim 4, wherein:
the fixing method includes: fixing the electric component by a solder; and removing a flux of the solder.

7. The condenser microphone according to claim 1, wherein:
the substrates includes: a mounting substrate; and a top substrate;
a vibrating film is laminated onto the base frame fixed onto the mounting substrate via a conductive spacer;
the top substrate is laminated on the vibrating film;
an electrode plate is arranged oppositely to a vibrating film conductive layer formed at the vibrating film;
the condenser portion includes the vibrating film and the electrode plate;
the base frame includes a conductive path for electrically connecting the conductive spacer and a conductive pattern of the mounting substrate; and
a top substrate conductive layer, which is provided at the top substrate, is electrically connected with the conductive spacer.

8. The condenser microphone according to claim 7, wherein:
the vibrating film conductive layer is provided at a surface on a side of the conductive spacer; and
the top substrate conductive layer and the conductive spacer are electrically connected by folding back the vibrating film toward a side opposed to the vibrating film conductive layer.

9. The condenser microphone according to claim 7, wherein
the top substrate conductive layer and the conductive spacer are electrically connected by contacting the conductive spacer with the top substrate conductive layer directly.

10. The condenser microphone according to claim 9, wherein
the top substrate conductive layer and the conductive spacer are electrically connected by contacting a peripheral edge of the conductive spacer with the top substrate conductive layer directly.

11. The condenser microphone according to claim 9, wherein
the top substrate conductive layer and the conductive spacer are electrically connected by contacting a contact portion, which is provided at the conductive spacer, with the top substrate conductive layer directly by penetrating the vibrating film.

12. The condenser microphone according to claim 9, wherein
the top substrate conductive layer and the conductive spacer are electrically connected by a projected portion that is provided at the top substrate conductive layer, penetrates the vibrating film, and contacts with the conductive spacer directly.

13. The condenser microphone according to claim 9, wherein
the top substrate conductive layer and the conductive spacer are electrically connected by a conductive connecting member arranged in a through hole formed at the vibrating film.
